(19) United States
(12) Patent Application Publication
(10) Pub. No.: US 2006/0024986 A1
(43) Pub. Date: Feb. 2, 2006

(54) ELECTROSTATIC DISCHARGE DISSIPATIVE SOCKETS

(75) Inventors: Patrick J. Rafter, Ulster Park, NY (US); Zenon A. Podpora, Pleasant Valley, NY (US); Qifang Qiao, Poughkeepsie, NY (US)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: International Business Machines Corporation, Armonk, NY (US)

(21) Appl. No.: 10/710,679

(22) Filed: Jul. 28, 2004

(51) Int. Cl. H01R 12/00

(52) U.S. Cl. 439/66

(57) ABSTRACT

The present invention relates to electrostatic dissipative alignment plates, sockets and socket assemblies comprising a base for providing an interface between an integrated circuit and an electrical system, and a frame for receiving the integrated circuit, where the base comprises an insulating material and the frame comprises a conducting material.

### BACKGROUND OF INVENTION

The present invention relates to alignment plates, sockets, and socket assemblies for interfacing integrated circuits (“ICs”) with electrical systems, and more particularly, to alignment plates, sockets, and socket assemblies having improved Electrostatic Discharge (“ESD”) dissipation characteristics.

Alignment plates, sockets, and socket assemblies adapted to receive ICs are conventionally used to provide a mechanical and electrical interface between an IC and an electrical system. For example, the alignment plate, socket, or socket assembly may serve as an interface between: an IC and a system board (e.g. a motherboard or daughter board), an IC and a test system (e.g. an electrical test system), or an IC and a burn-in test system (system for stressing ICs at elevated operating conditions). The IC may comprise one or more semiconductor chips that may or may not be positioned on a module or printed circuit board.

Various socket types are designed to hold a variety of IC products and are customized to accommodate the device leads of the IC, where the device leads refers to the electrical input/output connections (“I/O”) of the IC. Some examples of device lead types include: pin-grid-arrays (“PGA”), land-grid-arrays (“LGA”), ball-grid-arrays (“BGA”), column-grid-arrays (“CGA”) and the like.

The socket houses a plurality of electrical contacts for providing an electrical interface between the device leads of the IC and the electrical contacts of the electrical system to which the IC is being interfaced. The socket must have an alignment feature for properly positioning the device leads in the socket. The socket must also have a portion for housing electrical contacts and receiving the device leads of the IC. This socket portion must be made from an insulating material to prevent current leakage among the various electrical contacts. Leakage currents can cause malfunction of the IC.

Accumulation of electrostatic charge on the surface of the socket can occur during insertion or extraction of the IC from the socket. Electrostatic discharge (“ESD”) can cause damage to the IC and/or the electrical system to which the IC is being interfaced. The conventional approach for preventing ESD damage is to use electrostatic dissipative materials such as insulating plastics having conductive resin additives. However, the non-uniformity of such conductive resins can cause shorts or current leakage problems, especially inside the small holes which house the socket electrical contacts. Such an approach provides non-ideal ESD protection.

Conventional sockets typically do not address ESD. They are entirely built from insulative materials (e.g. Polyamid-imide, Torlon 5530, etc.). In commercial sockets where ESD prevention is attempted the IC interface component (alignment plate) is built from dissipative materials (10⁵ to 10¹⁰ Ohms/sq) which can cause current leakage.

Sockets typically comprise a guide plate for aligning the device leads of an IC with the electrical interface of an electrical system. Proper alignment is critical to assure that a particular IC is operated properly. Improper alignment can impact IC performance, reduce test and/or burn-in yields, or worse yet, can damage, often irreparably, the IC or the electrical system to which the IC is being interfaced. Conventional sockets typically comprise a single unit alignment formed from insulative material. The single unit alignment aligns the device leads of an IC with the electrical interface of an electrical system such as a system board, electrical tester or burn-in equipment. The single unit also has a second portion for housing the socket electrical contacts, which is also typically built from insulative material.

Conventional single-unit sockets are typically constructed of a plastic material that is in the insulative range (10¹² ohms/sq or greater) of the material's resistivity properties and do not offer sufficient ESD protection. There are no known ideal materials that can be used to construct single-unit sockets that solve this ESD problem.

### SUMMARY OF INVENTION

The present invention relates to electrostatic dissipative alignment plates, sockets, and socket assemblies having a base for providing an interface between an integrated circuit and a plurality of electrical conductors, and a frame for receiving the integrated circuit, where the frame is formed from a conducting material that prevents electrostatic charge buildup that may occur when the integrated circuit is either inserted into or extracted from the socket and the base is formed from an insulating material that prevents current leakage between electrical conductors.

The foregoing and other advantages and features of the invention will be apparent from the following more particular description of a preferred embodiment of the invention and as illustrated in the accompanying drawings.

### BRIEF DESCRIPTION OF DRAWINGS

The preferred exemplary embodiment of the present invention will hereinafter be described in conjunction with the appended drawings, where like designations denote like elements, and

FIG. 1 is a perspective view of an electrostatic dissipative alignment plate.

FIG. 2 is a bottom view of an electrostatic dissipative alignment plate as shown FIG. 1.

FIG. 3 is a cross-sectional side view of an electrostatic dissipative alignment plate as shown FIG. 1.

FIG. 4 is a perspective view of an electrostatic dissipative socket.

FIG. 5 is a cross-sectional side view of an electrostatic dissipative socket as shown FIG. 4.

### DETAILED DESCRIPTION

The present invention thus provides an electrostatic dissipative alignment plate, socket, and socket assembly for use with electrical systems that overcomes many of the disadvantages of the prior art. Specifically, the electrostatic dissipative alignment plate, socket, and socket assembly minimizes electrostatic charge buildup on the surface of the alignment plate, socket, and socket assembly by dissipating electrostatic charge through the conductive frame.

The invention will next be illustrated with reference to the figures in which the same numbers indicate the same elements in all figures. Such figures are intended to be illustrative, rather than limiting, and are included to facilitate the explanation of the process and device of the present invention.

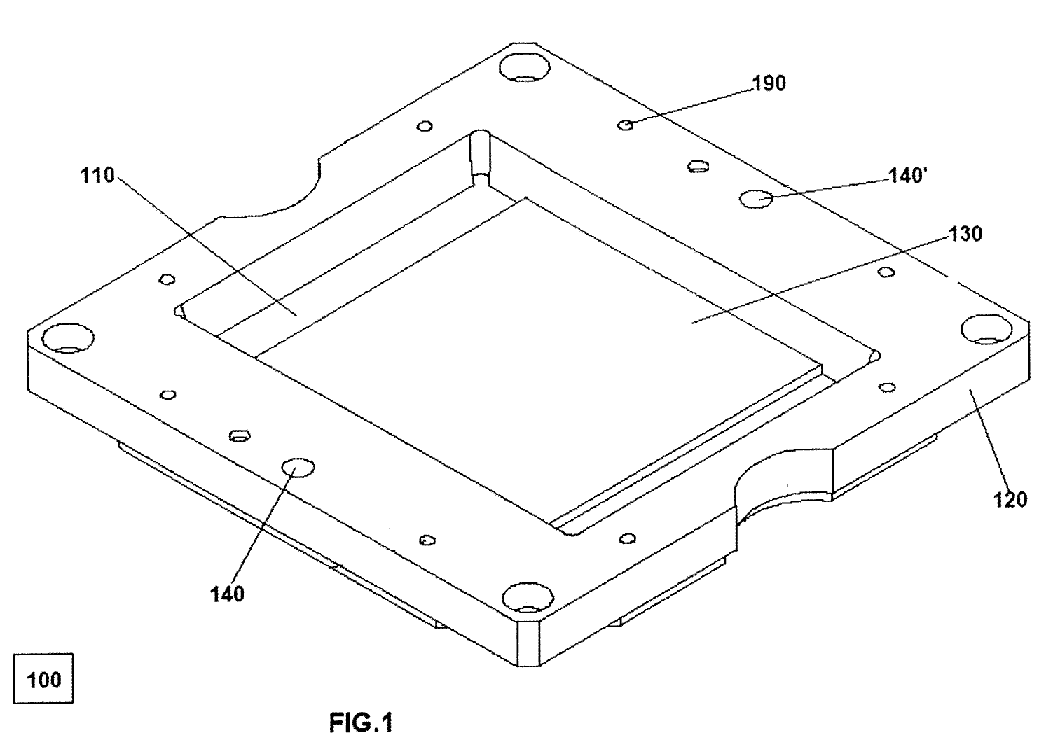

Turning now to FIG. 1, an exemplary electrostatic dissipative alignment plate 100 is illustrated in accordance with the present invention. The alignment plate 100 comprises base portion 110 and frame portion 120. Base portion 110 and frame portion 120 are formed from different materials to prevent electrostatic charge buildup in sockets and electrical systems and to prevent current leakage. Base 110 receives electrical conductors and also aligns the device leads of IC 130 when the IC is positioned in alignment plate 100. Base 110 has a plurality of openings for receiving electrical conductors which contact the device leads of IC 130, thus aligning and electrically coupling the device leads of the IC to the electrical system. IC 130 may comprise one or more semiconductor chips that may or may not be positioned on a module or printed circuit board.

Frame portion 120 is positioned on base 110 and receives IC 130. For IC devices with protrusion type leads, frame 120 provides coarse alignment for IC 130 when it is placed in alignment plate 100. Base 110 provides fine alignment for IC 130 as previously described. One or more pins may align frame 120 to base 110. Because base 110 and frame 120 are separate components, the pins may be removable, thus enabling either the base and or frame portions to be interchanged as need be. For illustrative purposes only, pins may be inserted into openings 140 and 140″ to align frame 120 to base 110. Additionally, fasteners such as screws may be inserted into multiple fastener openings 190 to attach frame 120 to base 110.

Base 110 is constructed from an insulating material and frame 120 is constructed from a conducting material. Because frame 120 is formed from a conducting material, it prevents electrostatic charge from building up on the mating surface of the alignment plate, thus preventing ESD from adversely effecting IC 130 or the electrical system to which the IC is coupled (e.g. a system board, test system, or burn-in equipment). Because base 110 physically contacts both the device leads of IC 130 and the electrical conductors inserted into the openings in the base, it is formed from an insulating material to avoid semiconductor device malfunction due to leakage currents.

To prevent electrostatic charge build up, frame 120 of alignment plate 100 can be constructed from any suitable conducting material having a surface resistivity less than <10⁶ Ohms/sq. For illustrative purposes, the conducting material can be graphite or carbon filled thermoplastics such as: Polyetherimide (e.g. Semitron 410 commercially offered by Quadrant Engineering Plastic Products, or Hydel PC7 commercially offered by Boedeker Plastics, Inc.), Polycarbonate (e.g. Zelux CN-P commercially offered by Westlake Plastics Company), and Acetal Copolymer (e.g. Pomalux CN-SS commercially offered by Westlake Plastics Company).

To prevent current leakage, base 110 can be constructed from any suitable insulating material having a surface resistivity of 10¹² Ohms/sq or greater. For illustrative purposes, the insulating material can be unfilled or glass-filled thermoplastics such as: Polyamide-imide (e.g. Torlon 5530 commercially offered by Quadrant Engineering Plastic Products), Polyimide (e.g. Vespel SP1 commercially offered by Dupont), Polyetheretherketone, Polyetherimide (e.g. Ultem commercially offered by GE), and Polyphenylenesulfide (e.g. Ryton commercially offered by Chevron Phillips Chemical Company LP, or Tecatron commercially offered by ENSINGER).

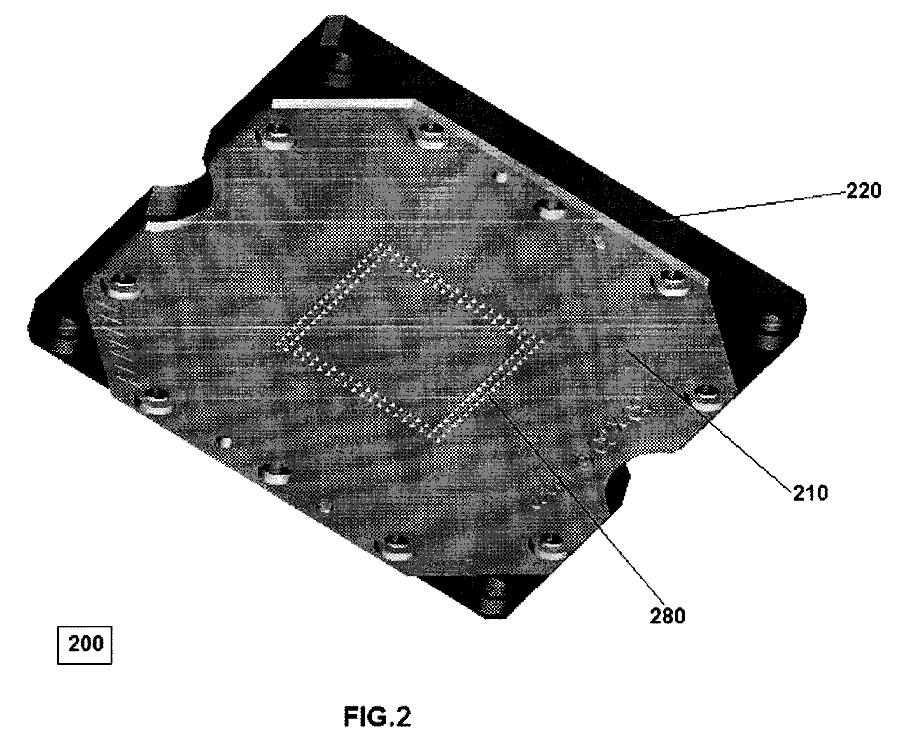

Turning now to FIG. 2, a bottom view of an exemplary electrostatic dissipative alignment plate 200 is illustrated in accordance with the present invention. Alignment plate 200 comprises base portion 210 and frame portion 220. Base 210 comprises openings 280. Electrical conductors can be inserted into the bottom portion of openings 280. Base 210 receives the electrical conductors via the bottom portion of openings 280 and also aligns the IC when the device leads of the IC are positioned in the upper portion of openings 280. The upper portion of openings 280 in base 210, which is not shown, align the IC by receiving the device leads of the IC when the IC is inserted into frame 220. The lower portion of openings 280 in base 210, which is shown, receive the electrical conductors, thus electrically coupling the IC to an electrical system when the IC is inserted into alignment plate 200. For illustrative purposes, if the IC comprises BGA type device leads, the BGA leads would sit, or be counter-sunk, in the upper portion of openings 280 which are not shown. The electrical conductors are inserted into the bottom portion of openings 280 which are shown and contact the BGA device leads.

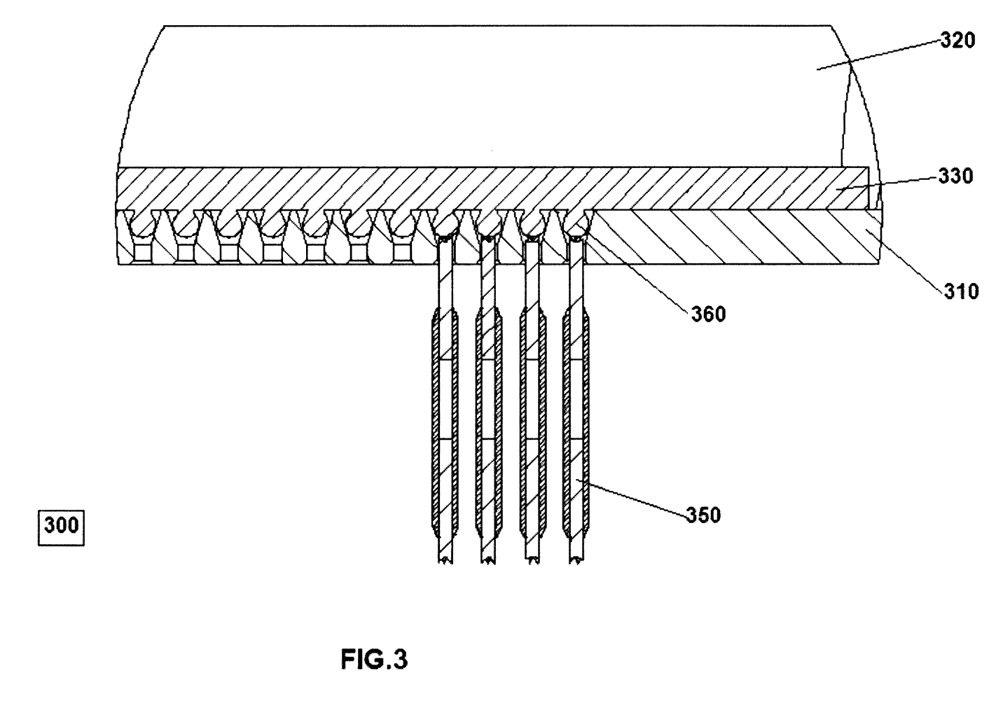

Turning now to FIG. 3, a cross-section of an exemplary electrostatic dissipative alignment plate 300 is illustrated in accordance with the present invention. Alignment plate 300 comprises base portion 310 and frame portion 320. Electrical conductors 350 can be inserted into the plurality of openings formed in base 310 as illustrated. Base 310 receives the electrical conductors and also aligns device leads 360 of IC 330 when the IC is positioned in alignment plate 300. Electrical conductors 350 may be any suitable conductor for contacting device leads 360 such as a pin, pad, column, and the like. Device leads 360 may be any suitable lead type such as PGA, LGA, BGA, CGA, and the like. Base 310 has a plurality of openings for receiving electrical conductors 350 which contact device leads 360 of IC 330 when the IC is inserted into the alignment plate, thus aligning the IC and electrically coupling the IC to an electrical system. For illustrative purposes, if IC 330 comprises BGA type device leads as illustrated in FIG. 3, the BGA leads would sit, or be counter-sunk, in the openings of base 310 as illustrated. The electrical conductors are inserted into the opposite end of the openings in base 310 and contact BGA device leads 360.

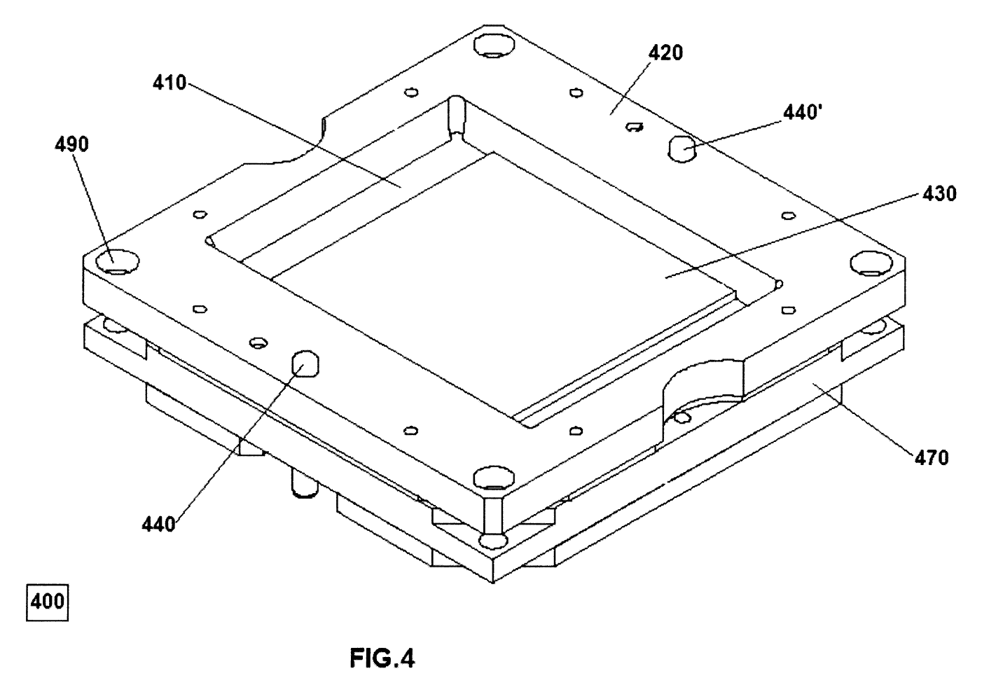

Turning now to FIG. 4, an exemplary electrostatic dissipative socket 400 is illustrated in accordance with the present invention. The socket 400 comprises base portion 410, frame portion 420, and housing portion 470. Base portion 410 and frame portion 420 are formed from different materials to prevent electrostatic charge buildup in sockets and electrical systems and to prevent leakage currents as previously described. Base 410 is interposed between housing portion 470 and frame portion 420. Alignment pins 440 and 440″ may be inserted into openings in frame 420, base 410 and housing 470 to align the frame and the base to the housing. Additionally, fasteners such as screws may be inserted into multiple fastener openings 490 to attach frame 420 and base 410 to housing 470.

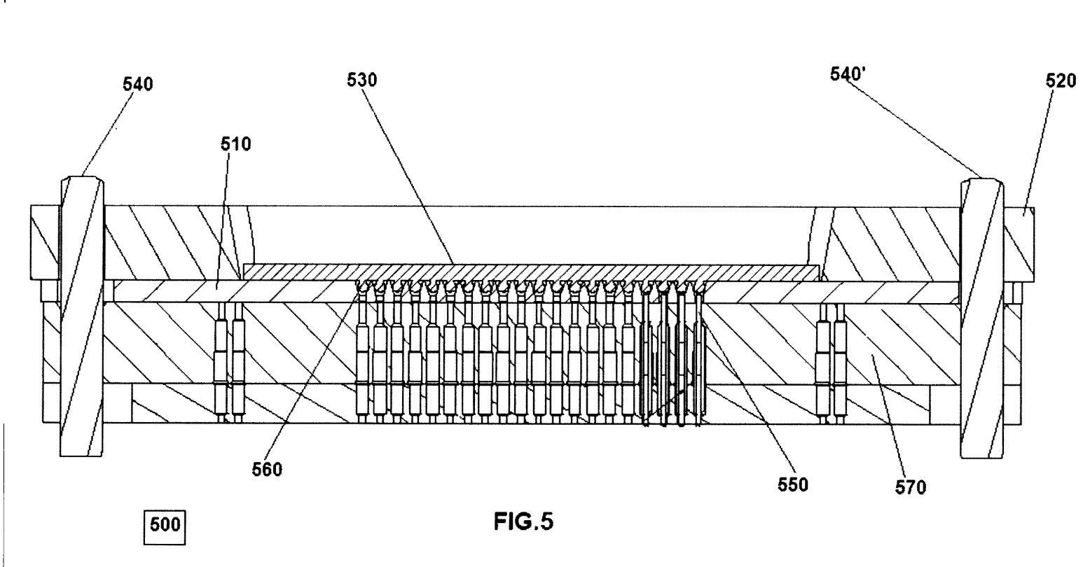

Turning now to FIG. 5, a cross section of an exemplary electrostatic dissipative socket 500 is illustrated in accordance with the present invention. Socket 500 comprises base portion 510, frame portion 520, and housing portion 570. Base portion 510 and frame portion 520 are formed from different materials to prevent electrostatic charge buildup in sockets and electrical systems and to prevent leakage currents as previously described. Base 510 is interposed between housing portion 570 and frame portion 520. Electrical conductors 550 are inserted into the openings in base 510 when socket 500 is assembled. Base 510 receives electrical conductors 550 and also aligns device leads 560 of IC 530 when the IC is positioned in socket 500. Base 510 has a plurality of openings for receiving electrical conductors 550 which contact device leads 560 of IC 530. Housing 570 contains, or houses, electrical conductors 550. When IC 530 is inserted into frame 520, the IC is aligned by base 510 as previously described, and electrical conductors 550 make physical contact with device leads 560, thus aligning the IC and electrically coupling the IC to an electrical system. Pins 540 and 540″ may align base 510 and frame 520 to housing 570. Alternately, the alignment plate 100 illustrated in FIG. 1 and the socket 400 illustrated in FIG. 4 may be mounted on a printed circuit board to form a socket assembly.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims. Accordingly, unless otherwise specified, any components of the present invention indicated in the drawings or herein are given as an example of possible components and not as a limitation. Similarly, unless otherwise specified, any steps or sequence of steps of the method of the present invention indicated herein are given as examples of possible steps or sequence of steps and not as limitations.

1. An electrostatic dissipative alignment plate, comprising:
a base adapted to provide an interface between an integrated circuit and a plurality of electrical conductors; and
a frame positioned on the base and adapted to receive the integrated circuit, wherein the base comprises an insulating material and the frame comprises a conducting material, wherein the conducting material has a resistivity of not greater than approximately 10⁶ Ohms/sq so that electrostatic charges are dissipated through the frame when the integrated circuit is inserted onto the frame.

2. The electrostatic dissipative alignment plate of claim 1, wherein the base has a plurality of apertures, wherein each one of the apertures is adapted to align the integrated circuit and to receive one of the plurality of electrical conductors.

3. The electrostatic dissipative alignment plate of claim 1, wherein the plurality of electrical conductors are coupled to an electrical system.

4. The electrostatic dissipative alignment plate of claim 1, wherein the integrated circuit comprises a plurality of device leads, wherein each one of the plurality of device leads is in contact with at least one of the plurality of electrical conductors.

5. The electrostatic dissipative alignment plate of claim 1, further comprising at least one pin adapted to align the frame to the base.

6. The electrostatic dissipative alignment plate of claim 1, further comprising at least one fastener adapted to attach the frame to the base.

7. The electrostatic dissipative alignment plate of claim 1, wherein the conducting material has a resitivity of approximately 10⁶ Ohms/sq or less and the insulating material has a resitivity of approximately 10¹² Ohms/sq or greater.

8. The electrostatic dissipative alignment plate of claim 1, wherein the conducting material is selected from the group consisting of: graphite, carbon filled thermoplastics, Polyetherimide, Polycarbonate, and Acetal Copolymer, and wherein the insulating material is selected from the group consisting of: unfilled thermoplastics, glass-filled thermoplastics, Polyamide-imide, Polyimide, Polyetheretherketone, Polyetherimide, and Polyphenylenesulfide.

9. An electrostatic dissipative socket, comprising:
a housing adapted to contain a plurality of electrical conductors;
a base positioned on the housing and adapted to provide an interface between an integrated circuit and the plurality of electrical conductors; and
a frame positioned on the base and adapted to receive the integrated circuit, wherein the base comprises an insulating material and the frame comprises a conducting material, wherein the conducting material has a resistivity of not greater than approximately 10⁶ Ohms/sq so that electrostatic charges are dissipated through the frame when the integrated circuit is inserted onto the frame.

10. The electrostatic dissipative socket of claim 9, wherein the base has a plurality of apertures, wherein each one of the apertures is adapted to align the integrated circuit and to receive one of the plurality of electrical conductors.

11. The electrostatic dissipative socket of claim 9, wherein the plurality of electrical conductors are coupled to an electrical system.

12. The electrostatic dissipative socket of claim 9, wherein the integrated circuit comprises a plurality of device leads, wherein each one of the plurality of device leads is in contact with at least one of the plurality of electrical conductors.

13. The electrostatic dissipative socket of claim 9, further comprising at least one pin adapted to align the frame and the base to the housing.

14. The electrostatic dissipative socket of claim 9, further comprising at least one fastener adapted to attach the frame and the base to the housing.

15. The electrostatic dissipative socket of claim 9, wherein the conducting material has a resitivity of approximately 10⁶ Ohms/sq or less and the insulating material has a resitivity of approximately 10¹² Ohms/sq or greater.

16. The electrostatic dissipative socket of claim 9, wherein the conducting material is selected from the group consisting of: graphite, carbon filled thermoplastics, Polyetherimide, Polycarbonate, and Acetal Copolymer, and wherein the insulating material is selected from the group consisting of: unfilled thermoplastics, glass-filled thermoplastics, Polyamide-imide, Polyimide, Polyetheretherketone, Polyetherimide, and Polyphenylenesulfide.

17. An electrostatic dissipative socket assembly, comprising:
a printed circuit board;
a base positioned on the printed circuit board and adapted to provide an interface between an integrated circuit and a plurality of electrical conductors; and
a frame positioned on the base and adapted to receive the integrated circuit, wherein the base comprises an insulating material and the frame comprises a conducting material, wherein the conducting material has a resistivity of not greater than approximately 10⁶ Ohms/sq so that electrostatic charges are dissipated through the frame when the integrated circuit is inserted onto the frame.

18. The electrostatic dissipative socket assembly of claim 17, wherein the base has a plurality of apertures, wherein each one of the apertures is adapted to align the integrated circuit and to receive one of the plurality of electrical conductors.

19. The electrostatic dissipative socket assembly of claim 17, wherein the conducting material has a resitivity of approximately 10⁶ Ohms/sq or less and the insulating material has a resitivity of approximately 10¹² Ohms/sq or greater.

20. The electrostatic dissipative socket assembly of claim 17, wherein the conducting material is selected from the group consisting of: graphite, carbon filled thermoplastics, Polyetherimide, Polycarbonate, and Acetal Copolymer, and wherein the insulating material is selected from the group consisting of unfilled thermoplastics, glass-filled thermoplastics, Polyamide-imide, Polyimide, Polyetheretherketone, Polyetherimide, and Polyphenylenesulfide.
